(19) United States
(12) Patent Application Publication
(10) Pub. No.: US 2009/0055889 A1
(43) Pub. Date: Feb. 26, 2009

(54) System and method for detecting and mitigating the writing of sensitive data to memory

(75) Inventors: Jacob Carlson, Brooklyn, NY (US); Kenneth Green, Baltimore, MD (US)

Correspondence Address: MCKENNA LONG & ALDRIDGE LLP, 1900 K STREET, NW, WASHINGTON, DC, 20006, US

(73) Assignee: TrustWave Corporation, Annapolis, MD (US)

(21) Appl. No.: 12/081,247

(22) Filed: Apr. 11, 2008

Related U.S. Application Data
(60) Provisional application No. 60/907,659, filed on Apr. 12, 2007.

(51) Int. Cl. G06F 21/24

(52) U.S. Cl. 726/1

(57) ABSTRACT

Disclosed is a system and method for detecting and mitigating the writing of sensitive or prohibited information to memory or communication media. The method includes detecting if an application is to write data to a memory, rerouting the writing of that data, and scanning the data for sensitive content or prohibited information. The scanning is done in accordance with one or more information security policies. If sensitive information is detected, the system has the option of issuing an alarm and/or preventing the sensitive information from being written, depending on the security policy. If the system permits the sensitive information to be written to memory, the system may spawn a file watcher object, which waits for a specified amount of time and then checks to see if the sensitive information has been deleted. If not, the system may issue an alarm or erase the sensitive information, depending on the security policy.

This application claims the benefit of provisional application Ser. No. 60/907,659, filed in the U.S. Patent Office on Apr. 12, 2007, which is hereby incorporated by reference for all purposes as if fully set forth herein.

### BACKGROUND OF THE INVENTION

1. Field of the Invention

The present invention generally relates to computer systems that process and record transactions, that may include sensitive information such as payment transactions information, financial transactions, medical information, etc.

2. Discussion of the Related Art

The payment industry's greatest concern, at present, is cardholder information (specifically PAN, track data and CVV2 data) being written to persistent storage (e.g. hard disk drive) in an unencrypted state. Indeed, credit card “track” and CVV2 data are not allowed to be stored at all after processing. During Payment Application Best Practice (PABP) assessments and incident response engagements, a consultant may perform manual investigation of known database and log and transaction files. However it is not feasible for the assessor to perform a thorough investigation of all transaction processing software and associated data stores. At some point it becomes necessary for the assessor to take the software vendor's word on the matter. This is not a sufficient process for providing assurance to merchants, acquirers or the card associations. Furthermore, sensitive payment data may have been stored on a system through some other means, such as receipt of email-based transaction.

One related art solution to mitigating persistent storage of sensitive information involves hard drive searches. This entails performing a thorough search of a system's hard drive to look for sensitive information. There are several drawbacks to this approach. First, these searches can take an exceptionally long time to complete. Second, unless slack and unallocated space is searched, it is possible that an application will delete a file containing sensitive information before the search gets to the offending file (also referred to as a race condition). Third, slack and unallocated space can only be searched when the disk is off-line and generally requires cumbersome and expensive software and equipment (e.g. Encase). Fourth, since data may be stored as either an ASCII a multi-byte e.g., (UNICODE) string, or some other format, and the disk data must be searched and analyzed multiple times, once for each string format. Fifth, in cases where remote “network drives” are involved, the time and scope of disk searches could increase dramatically.

Another related art solution involves searching a process's memory space for sensitive information. This approach has several disadvantages. First, it is not always possible to determine if a process will actually write the sensitive data to disk. Second, searching memory is a time-consuming process and thus will face the same race condition issues as hard-drive searches. Third, memory is typically moved around, freed, and modules are loaded and unloaded in an unpredictable fashion.

Accordingly, what is needed is a system and method for detecting an application attempting to write sensitive information to disk before it is written, and either prevent the application from writing it, or taking other measures such as alerting or reporting to assure that information security policies are being complied with.

### SUMMARY OF THE INVENTION

The present invention provides a system and method for detecting and mitigating the writing of sensitive data to memory that obviates one or more of the aforementioned problems due to the limitations of the related art.

Accordingly, one advantage of the present invention is that it better enables a financial service provider to assure that customers' data is being protected. Another advantage of the present invention is that it better enables a financial institution to comply with information security policies.

Another advantage of the present invention is that it enables a merchant to comply with information security policies.

Another advantage of the present invention is that it enables real time detection of security policy violations on a protected computer system.

Additional advantages of the invention will be set forth in the description what follows, and in part will be apparent from the description, or may be learned by practice of the invention. The advantages of the invention will be realized and attained by the structure pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates an exemplary system for detecting and mitigating the unauthorized writing and storage of sensitive information according to the present invention;

FIG. 2 is a diagram of an exemplary system, including a manager subsystem and a protected subsystem;

FIG. 3 illustrates an exemplary process for detecting and mitigating unauthorized writing and storage of sensitive information according to the present invention; and

FIG. 4 illustrates a method of hooking an applications call to the host operating system's systems libraries to intercept attempts to write data to secondary storage.

### DETAILED DESCRIPTION OF THE ILLUSTRATED EMBODIMENTS

The present invention involves a system that monitors an application for any writing it does to a memory, such as a disk or communication media, such as network connections, while the application is executing. The system identifies data that is considered sensitive before that data is written to memory. Once identified, the system may alert a user of the presence of the sensitive data. The system may further prevent the data from being written to memory. Alternatively, the system may allow the sensitive data to be written to memory. In the latter case, the system may store information (such as memory address information or time-stamp information) regarding the writing of the sensitive data so that the system may be able to quickly search the relevant space of the memory to confirm that the sensitive data has been erased according to some configured policy regarding allowed retention time.

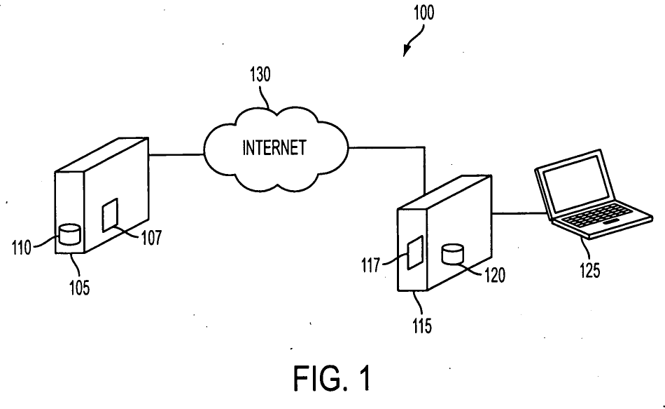

FIG. 1 illustrates an exemplary system 100 according to the present invention. Exemplary system 100 includes a protected computer 105 having a target processor 107 and a target memory 110; a manager computer 115 having a host processor 117 and a host memory 120 and a user interface 125. Protected computer 105 and manager computer 115 may be connected to each other over a network connection, which may include the internet 130.

Target memory 110 may include one or more memory devices that employ any of a number of storage media, such as magnetic media, semiconductor-based media, optical media, and the like. Same is true for host memory 120.

Protected computer 105 may include one or more computers that are used by a financial institution, bank, credit card company, payment service provider, a merchant that accepts credit card payments, or any such organization that routinely stores sensitive information. Target processor 107 may include one or more microprocessors, which execute instructions that may be stored on target memory 105, or another memory device accessible to protected computer 105.

Manager computer 115 may include one or more computers that are operated by an enterprise's internal staff, a security service provider, or other such organization, which undertakes to assure that protected computer 105 is operated according to one or more security policies pertaining to the safe use, storage, and disposal of sensitive information. Host processor 117 may include one or more microprocessors, which execute instructions stored on host memory 120, as well as other memory devices.

As used herein, the term security policy may refer to restrictions, audit mechanisms and specific configurations required by an organization, legal or regulatory bodies.

As used herein, sensitive information may include any data whose disclosure to unauthorized parties may result in financial, confidence or public image loss for the owner of the data. Examples include card account payment information, Social Security Numbers, medical data, and the like.

Host memory 120 is encoded with computer instructions and data for implementing processes according to the present invention. Host memory 120 may include one or more memory devices, which may be located within a single computer or distributed among a plurality of computers connected to each other over a network.

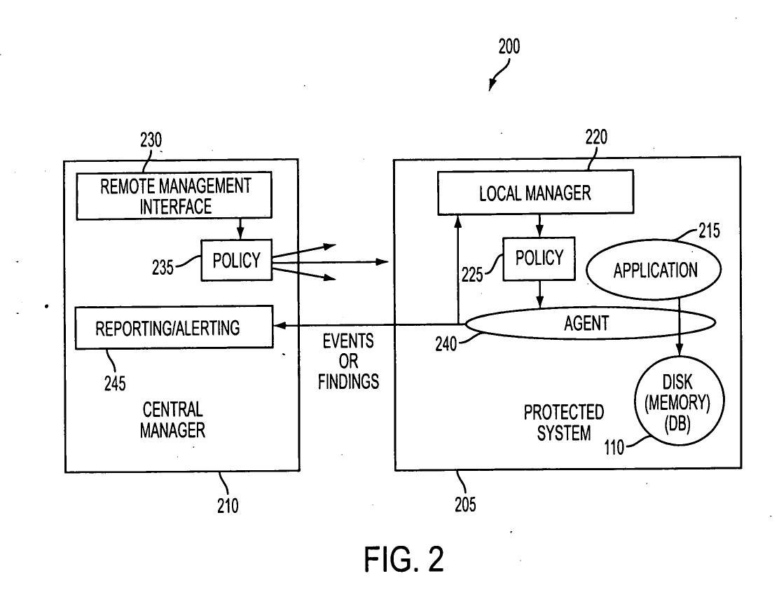

FIG. 2 illustrates exemplary functional components 200 of exemplary system 100. Functional components 200 include a central manager component 210 and a protected system component 205. Central manager component 210 may be implemented by the software stored on host memory 120 and executed by manager computer 115. Protected system component 205 may be implemented by the software that is stored on target memory 110, or another memory device, within protected computer 105.

Central manager component 210 may include a remote management interface component 230, a policy component 235, and a reporting/alerting component 245. Policy component 235 may include data stored on host memory 120, wherein the data includes rules and parameters corresponding to one or more security policies that pertain to the organization (e.g., financial institution) operating protected computer 105. The data corresponding to policy component 235 may also be stored in a database, or some other storage system, that is remotely located from manager computer 115 and operated by a different organization. In this case, the security policy represented by policy component 235 may be maintained by the organization that drafts such policies.

Protected system component 205 may include a local manager component 220, a local policy component 225, an application 215, and an agent component 240, all of which may include computer executable instructions and data. Agent component 240 may be provided to protected system component 205 by central manager component 210. In this case, software executed on host processor 117 may transmit the instructions and data corresponding to agent component 240 to target memory 110 so that target processor 107 can execute the instructions corresponding to agent component 240. When executing, agent component 240 may provide access to the software components executed by target processor 107 on behalf of central manager component 210. Further, agent component 240 may report pertinent information to central manager component 210 according to its instructions.

Application 215 may include a process, library, application component, or stand-alone application that processes or otherwise handles sensitive data. An example of application 215 is an application that writes data corresponding to credit card transactions to memory 110. Other examples include applications that write personal privacy information, such as Social Security Numbers, and the like.

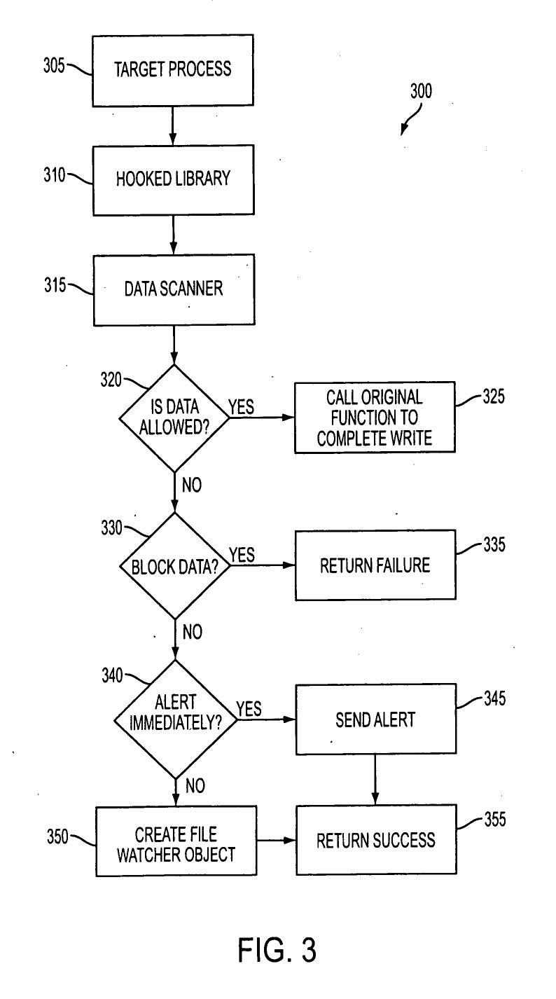

FIG. 3 illustrates an exemplary process 300 according to the present invention. Process 300 may be implemented by central manager component 210 in conjunction with agent component 240.

At step 305 application 215 (also referred to as the target process) makes a call to a library function that provides write-access to target memory 110. In doing so, the target processor 107 executes instructions on behalf of application 215.

The library containing the function requested by application 215 may include a plurality of functions, the instructions and data for which may be stored in target memory 110, or stored in another memory device accessible to protected computer 105. An Application Programming Interface (API) is an example of such a library.

At step 310, agent 240 intercepts the call to the library function by means of a hooking function stored in a hooking library that is within the instructions of agent component 240. In doing so, the target processor 107 executes instructions corresponding to agent component 240, which may do the following: (1) detect that target processor 107 has executed an instruction of application 215 to gain write-access to target memory 110; and (2) reroute the data that application 215 was to write to target memory 110 to another sector of memory determined by the instructions of agent component 240.

At step 315, target processor 107 executes instructions of agent component 240 to scan the data, which was rerouted by agent component 240, to search for sensitive or prohibited data. The data is scanned for patterns corresponding to policy-defined data. These patterns may be stored as data corresponding to agent component 240, which are accessible to target processor 107 when executing the instructions of agent component 240. The data corresponding to the patterns may have been part of the instructions and data transmitted from manager computer 115 to protected computer 105 when agent component 240 was installed in target memory 110. Alternatively, manager computer 115 may periodically provide pattern data to agent component 240 as new forms of sensitive or prohibited data arise.

At step 320, target processor 107 executes instructions corresponding to agent component 240 to decide whether the data scanned is allowed to be written to target memory 110. The instructions executed may include functions to data corresponding to local policy component 225. Local policy component 225 data may be stored in a dedicated sector of target memory 110, or some other memory device accessible to protected computer 105.

If it is decided at step 320 that the data scanned is non-sensitive, based on a query of local policy component 225, then process 300 proceeds via the “Yes” branch of step 320 to step 325.

At step 325, target processor 107 executes instructions corresponding to application 215 to write the data to target memory 110, as was originally intended.

If it is decided at step 320 that the data scanned is sensitive, then process 300 proceeds via the “No” branch of step 320 to step 330.

At step 330, target processor 107 executes instructions corresponding to agent component 240 to determine if the scanned data are prohibited. The instructions include functions that query local policy component 225 data for security policy information. If the data returned from local policy component 225 indicate that the scanned data is prohibited, then process 300 proceeds via the “Yes” branch of step 330 to step 335.

At step 335, target processor 107 executes instructions corresponding to agent component 240 to not allow the data to be written to target memory 110 as was intended by the instructions of application 215.

If it is determined at step 330 that the scanned data is not prohibited, process 300 then proceeds via the “No” branch to step 340.

At step 340, target processor 107 executes instructions corresponding to agent component 240 to decide whether to immediately send an alert. These instructions include functions that query local policy component 225 for data corresponding to the appropriate security policy. If the data returned indicates that an alert is to be issued immediately, process 300 proceeds via the “Yes” branch of step 340 to step 345.

At step 345, target processor 107 executes instructions corresponding to agent component 240 to send an alert. The corresponding instructions may include functions that send a message to reporting/alerting component 245 of control manager component 210. The message may contain information corresponding to the sensitive or prohibited data, and the security policy that was violated.

If it is determined at step 340 that an alert is not to be sent, then process 300 proceeds via the “No” branch to step 350.

At step 350, target processor 107 executes instructions corresponding to agent component 240 to create an file watcher object. A file watcher object may be a software entity having a plurality of instructions and data, which may periodically scan a sector of memory 110 that contains the data written to by application 215. This is the data that application 215 originally intended to write, which agent component 240 determined to have sensitive data.

Certain security policies for controlling the writing of sensitive data may permit the sensitive data to be written to disk, provided that the data is removed after a security policy-determined amount of time. A typical duration of time until the sensitive data must be removed may include, for example, 24 hours, one week, or one month. Accordingly, local security component 225 may include data corresponding to the amount of time for which the sensitive data may reside in target memory 110 without violating the security policy.

Target processor 107 may execute instructions corresponding to the file watcher object, which may do the following: (1) obtain the permissible write time from local policy component 225; (2) count the amount of time elapsed since the sensitive data was written to target memory 110; (3) take action if the sensitive data still resides in target memory 110 after the permissible write time has elapsed. Actions to be taken may include sending a message to reporting/alerting component 235, and/or purging the sensitive data from target memory 110. The action to be taken may be dictated by the security policy data in local policy component 225.

At step 355, the data are written to target memory 110 as originally intended. To do this, target processor 107 may resume executing instructions corresponding to application 215. At the completion of step 355, target processor 107 concludes the execution of process 300 and returns to executing instructions of other processes running on protected computer 105.

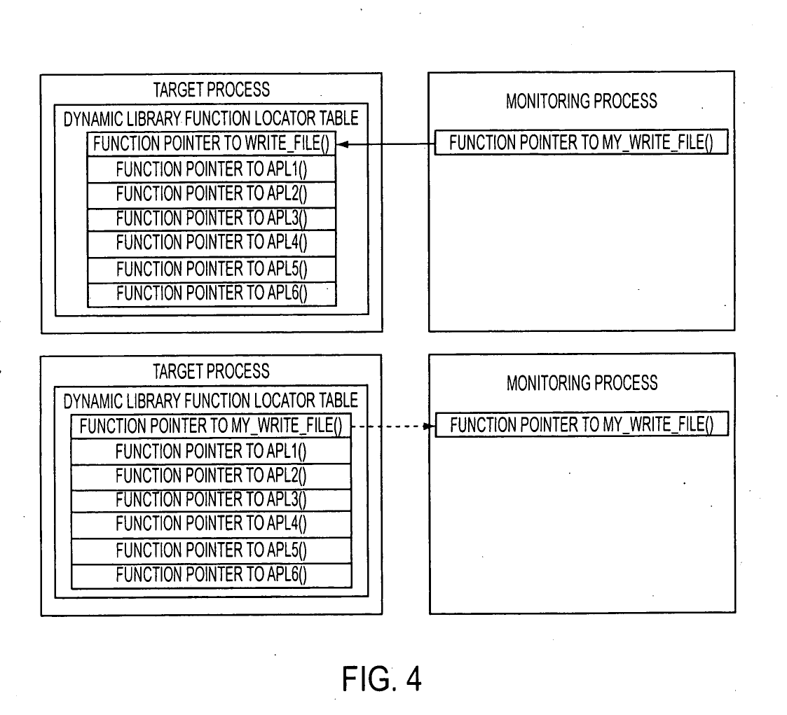

FIG. 4 illustrates an exemplary process 400 for intercepting attempts by a target process to write to a memory according to the present invention. Process 400 may be implemented by agent component 240, and may be implemented within steps 305 and 310 of process 300.

In process 400, target processor 107 executes instructions corresponding to agent component 240 to locate entries in application's 215 memory space that describe the location of functions that support writing to memory. The instructions include a function that overwrites the function locations with addresses controlled by agent component 240 or its associated libraries included with its instructions.

Accordingly, whenever application 215 attempts to execute a function intended to write data to target memory 110, it is intercepted by agent component's 240 function.

There are several ways by which central manager component 210 obtains data corresponding to policy component 235 and provides this data to local policy component 225: on installation; via periodic refresh; via refresh with change in policy.

Central manager component 210 may maintain policy component 235, which includes security policy data, on host memory 120. Host processor 117 may execute instructions corresponding to central manager component 210 to periodically obtain or receive security policy information from external sources, such as websites maintained by security organizations and other institutions.

When an agent component 240 is installed in a protected computer 105, host processor 117 may execute instructions corresponding to central manager component 210 to transmit data corresponding to one or more security policies appropriate for the organization that operates protected computer 105. These instructions may include functions that transmit the data corresponding to these security policies from policy component 235 along with instructions to create a local policy component 225 in target memory 110, which contain this security policy data.

Selecting which security policy to transmit to local policy component 225 may be done by security personnel within the organization that operates protected computer 105. In this case, security personnel may log into manager computer 115 and interact with central manager component 210 via remote management interface 230. Using remote management interface 230, security personnel may select which security policy they wish to have implemented on protected computer 105. With the security policies selected, central manager component 210 may transmit the data corresponding to these security policies from policy component 235 to local policy component 225.

In maintaining security policy data on local policy component 225, host processor 117 may execute instructions corresponding to central manager component 210 to query databases and websites of security organizations to determine if any changes have been made to existing security policies, or if new security policies have been created. If this is the case, the instructions may further include functions to update or add security policy data to local policy component 225.

In an alternate embodiment, remote management interface 230 may reside in protected computer 105. In this case, the above described processes of selecting and updating security policy data may be performed by functions executed on target processor 107. Further, all of the components illustrated in FIG. 2 may reside and be executed in a single computer, which may be protected computer 105.

Although the above description of process 300 pertains to monitoring a single application 215, one skilled in the art will readily appreciate that this may also pertain to multiple applications 215 or services.

Although the above describes hooking at the API level in order to intercept application 215 writing to target memory 110, the hooking may be done via other ways, such as hooking within the operating system kernel. One skilled in the art will readily appreciate that such variations for detecting and rerouting the writing to memory are possible and within the scope of the invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for detecting an attempt to write sensitive data to a memory, comprising:
detecting that an application has a function to write data to the memory;
rerouting the writing of the data to a separate memory location;
scanning the data for sensitive data content;
identifying sensitive data content within the data;
querying at least one security policy for an instruction whether to permit writing of the sensitive data content to the memory;
permitting the application to write the sensitive data content to the memory, depending on the at least one security policy;
waiting for an amount of time specified by the at least one security policy; and
determining if the sensitive data content is present in the memory after the amount of time.

2. The method of claim 1, wherein identifying the sensitive data content comprises issuing an alert.

3. The method of claim 1, wherein determining if the sensitive data content is present in the memory comprises issuing an alert if the sensitive data content is present.

4. The method of claim 1, wherein determining if the sensitive data content is present in the memory comprises erasing the sensitive data content.

5. The method of claim 1, wherein the waiting for the amount of time is based upon a retention time of the at least one security policy.

6. A computer readable medium encoded with instructions for detecting an attempt to write sensitive data to a memory, the instructions comprising:
detecting that an application has a function to write data to the memory;
rerouting the writing of the data to a separate memory location;
scanning the data for sensitive data content;
identifying the sensitive data content within the data;
querying at least one security policy for an instruction whether to permit writing of the sensitive data content to the memory;
permitting the application to write the sensitive data content to the memory, depending on the at least one security policy;
waiting for an amount of time specified by the at least one security policy; and
determining if the sensitive data content is present in the memory after the amount of time.

7. The computer readable medium of claim 6, wherein identifying the sensitive data content comprises issuing an alert.

8. The computer readable medium of claim 6, wherein determining if the sensitive data content is present in the memory comprises issuing an alert if the sensitive date content is present.

9. The computer readable medium of claim 6, wherein determining if the sensitive data content is present in the memory comprises erasing the sensitive data content.

10. The computer readable medium of claim 6, wherein the waiting for the amount of time is based upon a retention time of the at least one security policy.
